(19) United States
(12) Patent Application Publication
(10) Pub. No.: US 2009/0287466 A1
(43) Pub. Date: Nov. 19, 2009

(54) Process For Carrying Out A Task For Calculating A Signal To Be Simulated In Real Time

(75) Inventors: Jurgen Klahold, Brakel (DE); Karsten Krugel, Paderborn (DE); Bjorn Muller, Lippstadt (DE)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: dSpace digital signal processing and control engineering GmbH

(21) Appl. No.: 12/432,947

(22) Filed: Apr. 30, 2009

(30) Foreign Application Priority Data
May 13, 2008 (DE) 08008827.1

(51) Int. Cl. G06F 13/10; G06F 9/46; G06F 9/44

(52) U.S. Cl. 703/21; 718/107

(57) ABSTRACT

The invention relates to a process for carrying out at least one task for calculating at least one signal to be simulated in real time by a task manager implemented on a data processing system with a real-time operating system in software, which manager periodically starts a task after a time period that is given or can be given which task calculates at least one output signal from at least one given input signal which output signal is a function of it, characterized in that a set of at least two different tasks with different calculation times for calculating the same at least one signal to be simulated is stored in an executable manner in the data processing system, and at least one minimal task has a calculation time shorter than the time period, in which the task manager starts at least one of the tasks from the set according to a stored strategy with which a calculation result of at least one of the tasks from the set is obtained while maintaining the real time within the given time period.

The invention relates to a process for carrying out at least one task for calculating at least one signal to be simulated in real time by a task manager, implemented in software, on a data processing system with a real-time operating system, which task manager periodically starts a task after a given time period which task calculates output signals from given input signals that are a function of them.

The simulation of factual conditions of the real world technically by data processing systems is known in the state of the art. In particular, for testing technical components such as, for example, control devices, in particular vehicle control devices, it is preferred to carry out a real-time simulation, i.e., a simulation in which an outside observer perceives the events produced by the simulation as though they would actually happen in real time.

Problems regarding the calculation time and the quality of the calculations carried out can occur in real-time simulation by too complex models. Accordingly, it can happen that problems occur when using too complex models, for example, that the maintaining of the real time during a simulation can not be ensured with achieving of correct calculation results at the same time.

For example, such problems can arise by using models different from the known average value models in the motor simulation. As a rule, the Euler's method with a fixed step size for the numeric approximation of physical systems is used today. It is difficult for an engineer to find a step size in it that on the one hand ensures the numeric stability of the entire system and on the other hand does not endanger the real-time capability of the system at any time. Thus, it can occur that models that are too complex are programmed that require too great a calculation time and therefore cannot deliver the simulation result in real time. The concept of the complexity of calculation tasks to be carried out denotes in the invention described here that the calculation time of a task rises with rising complexity. A task here is a calculation instruction for calculating output signals from input signals that are dependent on them. Thus, on the whole the desire for greater complexity or, however, the necessity for greater complexity can endanger the real-time capacity of the calculations to be carried out for this.

Thus, it is known in the state of the art, as initially mentioned, that a task can be carried out in order to calculate a signal to be simulated, in which case it can be provided, as is known, that a task manager implemented in software is used that periodically starts such a task after a time period that is given or can be given.

Previous programmings were carried out in such a manner that a task to be started concluded its calculation within the given time period in a guaranteed manner in order not to endanger the real-time capability. It can occur here in individual instances that the conclusion of the calculation does not exhaust the available calculation time within a given time period, for example, since the task performed at certain times or under certain given circumstances was able to be calculated more rapidly than expected. It thus turns out that in such a situation a more precise task could have been calculated that was actually performed. The calculating capacities of the simulating data processing system are accordingly obviously not exhausted for always remaining on the safe side of the real-time capacity.

It is furthermore known in the state of the art that in order to achieve the greatest possible precision while retaining the real-time capacity at the same time that a decision be made before carrying out a simulation whether a desired factual condition is to be calculated with a model modulated in a simple manner, thus, for example, with a task with a low calculating time or with a complexly formulated model, that is, with a task with a higher calculating time.

A disadvantage of this solution is that it must always be determined before the simulation already with which complexity a calculation should be carried out. The decision of selecting a complex task with a higher calculating time is, however, problematic here since one can not always decide in an unobjectionable manner in advance, that is, before the actual carrying out of the simulation, whether there is the possibility of actually calculating the complexly formulated task while maintaining the real time under the concretely given condition.

A program with the designation Mosilab of the Fraunhofer Institute is known in the state of the art that also attempts to solve this problem, in which a decision is made before every calculation of a task whether a factual condition is to be calculated with the complex or with a simple task. Thus, it is known in conjunction with the Mosilab software that a distinction can be made between interesting states of a system, e.g., that result by the calculation of previous tasks or decisions and between less interesting states of a system and to select in a manner independently of the above the calculation of simple or complex tasks before the simulation. For example, in the simulation of the manner of operation of a solar plant a decision can be made at night before the simulation of its behavior to save calculating costs. Furthermore, a decision can be made prior to a task whether a simple or a complex task is to be calculated; however, it cannot always be estimated in advance whether a complex task can be calculated in real time. Thus, even the Mosilab software is not suitable for influencing the tasks to be calculated and their complexity and the associated calculating time during the performance of a real-time simulation.

The invention has the problem of making a method of the initially cited type available that creates the possibility of guaranteeing the maintaining of the real time during the run time of the simulation and at the same time exhausts all possibilities for obtaining the most precise simulation results possible in the calculation. The carrying out of the initially cited tasks for complete models of a signal to be simulated or, however, also of a partial model for the simulation of a signal can be provided. The disadvantages of the state of the art, according to which always only one task is calculated that leads in a guaranteed manner to the conclusion of the calculation within the given time period should be eliminated. Moreover, technical frame conditions should be reacted to flexibly and without expense by the user. Thus, it should be taken into consideration, e.g., that if necessary more complex tasks can be calculated in real time on a rapid processor than on a slower processor.

The invention solves the problem in that in a generically cited process a set of at least two different tasks with different calculation times for calculating the same signal to be simulated is stored in an executable manner in the data processing system, and at least one minimal task has a calculation time shorter than the time period, in which the task manager starts at least one of the tasks from the set according to a stored, e.g., given or learned strategy with which a calculation result of at least one of the tasks from the set is obtained while maintaining the real time within the given time period. The mentioning that the task manager periodically starts a task does not exclude, in particular according to the invention, that tasks can also be aperiodically started by the task manager in accordance with the strategies described in the following.

The term “a signal to be simulated” denotes every possible physical magnitude that can be represented by a calculation result of a task such as, e.g., electrical, optical or acoustic signals, in the case of electrical signals in particular analog or digital signals such as, e.g., voltages or currents. Such signals can be represented, e.g., by numerical values resulting from the calculations of a cited task. It can also be provided in particular that actual physical signals are formed from the calculation results of the simulation, e.g., by digital-analog conversion, the controlling of actuating drives, etc.

Thus, the essential core concept of the invention is to model a signal to be simulated in a task not only with a single complexity and the associated calculation time but rather to model the signal in different models with differing complexity and the associated differing calculation time. Thus, according to the invention there is the possibility of selecting one or more task(s) for the calculation from the tasks present in the set of differing complexity and calculation time using the stored strategy, and thus to always obtain the calculation result of at least one of the tasks within the given time period. In order to be able to guarantee the simulation in real time in every instance, the invention provides that one of the tasks has such a low complexity and calculation time that this task can always be carried out in a guaranteed manner within the given time period. This task, that is one task from the set of the total available tasks in the data processing system, will subsequently be designated as the minimal task in order to be able to differentiate it from the other possible tasks.

The strategy stored in the data processing system, especially in the task manager made available and implemented in software, can also be implemented in the software and determines how the task manager used periodically starts one or also several tasks from the available set after the expiration of said time period associated with it. The strategy of the invention here is selected and implemented in software in said data processing system in such a manner that, as initially cited, a calculation result can always be obtained in real time within the available time period. To this end several alternative strategies can be used in accordance with the invention.

It can be provided in a possible alternative that at first the minimal task is started by the task manager in accordance with the stored strategy, after whose expiration at least one further task is started from the set with a greater calculation time than that of the minimal task, in which after the expiration of the time period a still-running task is stopped and the calculation result is taken as simulation result by the task that meets a deciding criterion that is given/can be given.

For example, the deciding criterion can be the (in particular greatest) calculation time and/or (in particular greatest) calculation precision and/or the (in particular) smallest simulation step size and/or the solver or combinations thereof. A solver is an algorithm that in this special instance calculates the numeric solution of a DAE (differential algebraic equation) or a DGL (differential equation). Known solvers are, e.g., method according Euler, Heun, Runga-Kutta. Thus, in a possible embodiment, e.g., the calculation result can be taken by the task with the greatest calculation time.

It is ensured by starting the minimal task at first, that guarantees a calculation time that is smaller than the time period, that at least one calculation result is obtained during the simulation, namely that of the minimal task. Since the calculation time of the minimal task is always smaller than the time period, a residual time therefore always remains after the termination of the minimal task in which at least one further task can still be started from the set of the available tasks. Thus, such a task is one that has a greater calculation time and therefore supplies a more precise calculation result in comparison to the minimal task. Thus, according to this strategy at first the calculation result is ensured in order to then attempt to obtain a more precise calculation result within the remaining time until the end of the time period.

It can either be provided here that after the termination of the calculation of the minimal task only a single further task is started. If the end of the time period is reached during the run time of this task, this task is stopped and the result of the minimal task used. It can also be provided that after the termination even of the further task yet a further task is started. For example, it can be provided here that another task in the series of rising calculation time is started from the set of tasks, starting with the minimal task. Thus, after the ensuring of an obtained calculation result that can be stored, for example, in an intermediate manner, a continuous attempt is made until the end of the expiration of the time period to obtain even more precise calculation results by a continuing subsequent starting of more and more complex, i.e. more calculation-time-intensive tasks. It can always be provided in this calculation of the tasks, that takes place serially here and begins with a minimal task, that the task still running at the end of the time period is stopped and thus its result, for example, an intermediate result, is rejected.

In another alternative it can also be provided that a task from the set with a calculation time greater than that of the minimal task is started in accordance with the stored strategy, that a timer is started with the starting of this task, and that the task manager stops the started task and starts the minimal task as a function of the difference of time period and time value of the timer.

Thus, according to this strategy the attempt is made to obtain a calculation result that is more precise than the calculation result that the minimal task would make available with the lowest calculation time. Accordingly, the task is started whose calculation time deviates from that of the minimal task, for which the calculation time of the minimal task is preferably known and stored. Even the calculation times of the remaining tasks, at least expected calculation times of the remaining tasks, can be known and stored so that even these expected calculation times can be available for selection in the framework of the strategy. The expected calculation times do not have to be actually known as time, but it is also sufficient if the individual tasks given in the set only have a sequence regarding their calculation time that can equal, for example, a priority.

It is ensured with the simultaneously starting of a timer that information about the already elapsed time of the calculation is available at all times during the run time of the task. Accordingly, based on the known calculation time of the minimal task, care can be taken that a started task can be stopped at the proper time in order to be able to still carry out the minimal task until the termination of the calculation in a guaranteed manner after the stopping of this task within the remaining time until the end of the time period. Thus, the attempt is made in accordance with this strategy to obtain a more precise calculation result; however, in any case the execution of the minimal task is started in a timely manner in order to obtain the calculation result for this minimal task if the calculation of the previously started task can not be concluded in a timely manner.

Thus, it can be provided here that the stopping takes place at a time value of the timer when the difference of the time period available on the whole for the calculation and of the time value of the timer is greater by one safety time than the calculation time of the minimal task. In particular, the time buffer made available by the safety time can be provided in order to compensate deviations in the calculation time of the minimal task from the stored theoretical calculation time for this task.

In order to technically realize the stopping of the running task and/or the starting of the minimal task, the use of an interrupt can be provided. Interrupts are known in data processing systems and can function in such a manner, for example, that an interrupt signal line is drawn on a certain signal level provided for the interrupt in order to initiate the interrupt.

If a data processing system receives such an interrupt signal, a branching to an address in the memory of the data processing system can take place, after which a program stored there is executed. Thus, there can be the possibility here that such an interrupt is initiated as a function of the time value of the timer, thus, in particular when the difference of time period and time value is greater by one safety time than the calculation time of the minimal task, for example in that an appropriate interrupt signal is generated by a timer module in which the time is counted up, for example in that an appropriate interrupt line is put on the initially cited signal level required for this, in particular a ground level.

Thus, a check can then be made with a procedure started by the interrupt, which can be a procedure of the task manager, whether the originally started task has already ended. If this is not the case, this task is stopped and the minimal task started. However, if the task has already ended, it can be provided for example that the task manager waits until the expiration of the time period, thus, it starts no further tasks. Alternatively, it can also be provided that upon the termination of the task before the interrupt the task manager starts another task from the set of tasks with an expected calculation time that is greater than that of the terminated task. Thus, there can be the possibility here of achieving an even more precise result by the end of the time period, given the calculation time that is still available.

A possible embodiment of the invention can provide that in this type of sequential processing that task can be started from the set that has the greatest expected calculation time and/or is known to the system as the task with the highest calculating precision. Thus, the system can always try at first to achieve the most precise calculation result possible but stop the calculation and start the minimal task if this calculation was not able to be carried out in a timely manner in a time that makes sufficient residual time for the alternative execution of the minimal task.

It can be provided in particular in the periodic sequence of the process that a task is started from the set whose expected calculation time is less than the timer time upon the stopping of the task in a previous calculation period. Thus, there is the possibility here of implementing a type of learning of the task manager from empirical values from the past. If it turns out, for example, in a previous processing period that the selected task had not been terminated in a timely manner, therefore, the minimal task had been started for the sake of safety, it can be provided in a following period that a task is selected with a lesser complexity or calculation time. Since a timer time had been determined in the previous period according to which the previously started task had been stopped, a task can now be selected whose calculation time probably to be expected is less than this timer time in order to achieve with likelihood that this task can be executed to end before an interrupt. Thus, the task manager can learn from the previous results and attempt to optimize the selection of the tasks available in the set and it can be accordingly provided in this embodiment that the most concrete information possible about the calculation time likely to be expected of the individual tasks is additionally stored in the data processing system.

In another alternative that can form the strategy for starting the tasks by itself and can also be combined with the previously cited serial strategies, it can be provided that the data processing system comprises several processors working in parallel and that the task manager starts the minimal task and at least one further task from the set in parallel on each one of the processors, in which after the expiration of the period time the calculating result is taken as simulation result by the task of the parallel tasks that has the highest calculation time from the completely executed tasks and therefore the highest precision of the result. Thus, it is ensured here too in any case by the parallel processing that the minimal task supplies a calculation result and that a chance is obtained by the parallelism of the calculation of likewise bringing a task to its conclusion in this calculation within the available time period that has greater precision than the minimal task. In as far as this is the case, the result of the task with a higher calculation time, preferably of the task with the highest calculation time is accordingly taken as the simulation result according to this stored strategy. As mentioned, it can be provided here that the further behavior of the calculation on a processor takes place on each of the processors operating in parallel after the start of a particular task in such a manner as was initially described for the serial strategies. Thus, there can accordingly be the possibility that optionally several calculation results are made available from each of the processors operating in parallel, and the most precise calculation result, that is, the one with the highest calculation time is accordingly taken via the set of all calculating ones in accordance with the invention.

As initially mentioned, a set of several tasks is made available here for a data processing system that can all calculate a simulation result for the same signal to be simulated but require different calculating times for this. At least one of the tasks is designed as minimal task, that has a guaranteed calculation time that is less than the available time period. Differences in the calculation time of the individual tasks can result, e.g., in that the step size with which the tasks perform calculations is selected in a different manner. Accordingly, a task with a higher calculation time can have a smaller step size than a task with a smaller calculation time. Calculation times can also differ by the solver with which the texts are calculated. Thus, a complex task, that is, one with a higher calculation time, has a solver that is just as more complex than a task with a lesser complexity.

Further differences in the calculation time can also result from the fact that the equations that are calculated within a task have different precisions but preferably, however, always with the same number of states, in particular therefore input parameters for the equations. Thus, more precise equations can accordingly be used for tasks with higher calculating times.

Further differences in the calculation time can also result from the fact that the number of the functions to be calculated or the number of the parameters used for the calculation are different. If it is provided in an example to be understood here in a non-limiting manner that the function of a brake anti-locking system is to be simulated, then only ALS functions such as, for example, the brake pressure and the wheel rotation can be detected, for example, in a task with a smaller calculation time. In contrast thereto, in a task with a higher calculation time additional functions and parameters for the previously cited ones such as, for example, brake assistant functions can also be taken into consideration such as the speed with which one steps on the brake pedal and/or the speed with which the gas pedal is released.

It can also be provided in a further development that can be combined with all possible embodiments that the time period according to which the tasks are started is changed. A re-programming of the time period can take place, e.g., during the run time of the current time period so that after its expiration following changed time periods follow.

It can also be provided in general that the cited process in accordance with the invention is used not only for a single signal to be simulated but rather for many different signals that are also calculated in parallel, if required.

The process of the invention presented here can be realized technically in different ways. For example, it can be provided that the process runs on a data processing system with which a test environment is simulated for a real electronic control device, for example, a vehicle control device, and in which signals and/or data from the simulated environment of the control device are supplied to the real control device by the data processing system and the control device sends real signals and/or calculated data to the data processing system. Thus, a data exchange of real and simulated signals and/or data accordingly takes place here between a data processing system on which the process of the invention is running and an actual real electronic control device. This communication of signals or data can take place, for example, in a line-bound manner via electrical or optical signal lines also via radio. The appropriate signals can be made available on the ports of the particular data processing system or of the electronic control device provided for this purpose for transmission or received.

It can also be provided in another alternative that the process is performed on a real electronic control apparatus such as, for example, a vehicle control apparatus in order to simulate its control behavior, in which case signals and/or data are supplied to the control device from the real control device environment, for example, by sensors and measured-value receivers and in which the control device emits simulated signals and/or data calculated in a simulated manner to the control device environment, for example, to actors. Accordingly, an appropriate communication also takes place here that can be performed in the same manner as was cited for the previous embodiment.

It can also be provided in yet another possibility that the process runs on a data processing system by means of which the control behavior of a control device, in particular of a vehicle control device, is simulated, in which signals and/or data are supplied to the data processing system from the real control device environment, in particular from sensors and measured-value receivers, or however, a simulation is also provided here, thus, for example, by a data processing system for the simulation of a control device environment and simulated signals and/or data are supplied to the real or simulated control device environment from the data processing system simulating the control behavior. Accordingly, a communication of signals and data takes place here again in both directions and the devices participating in this communication can either be real or are simulated for their part.

Thus, in sum there is the possibility with the process in accordance with the invention of making the real-time capacity of simulations with obtention of the most precise calculation results possible available in different technical applications.

Exemplary embodiments of the invention are shown in the following figures.

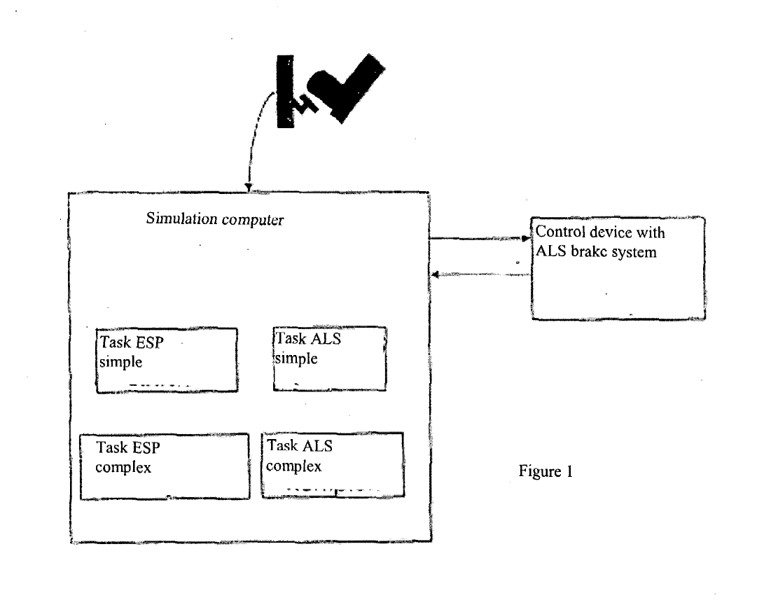

FIG. 1 shows a variant in which a simulation computer simulates the environment for a concrete control device,

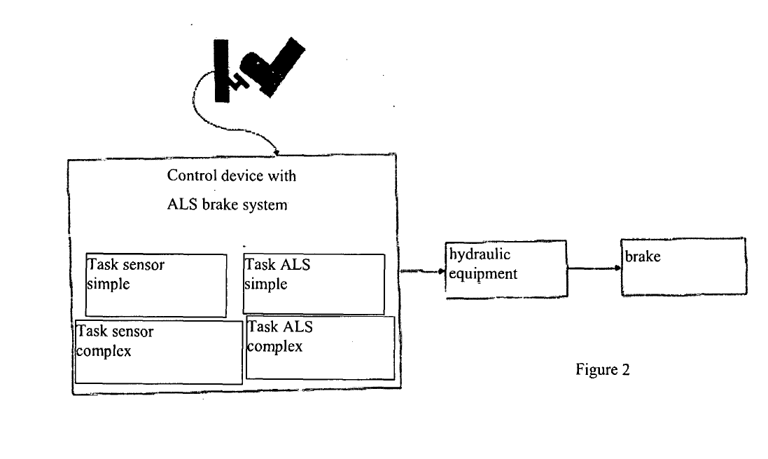

FIG. 2 shows a variant in which the simulation of the control device takes place in the control device itself,

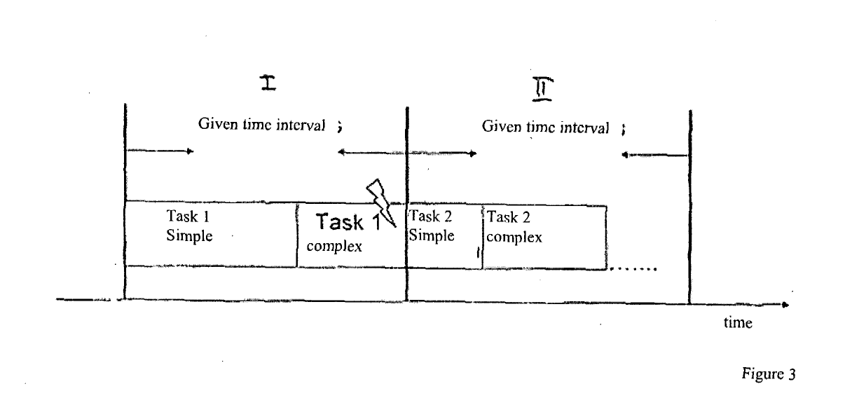

FIG. 3 shows the serial starting of tasks beginning with a minimal task,

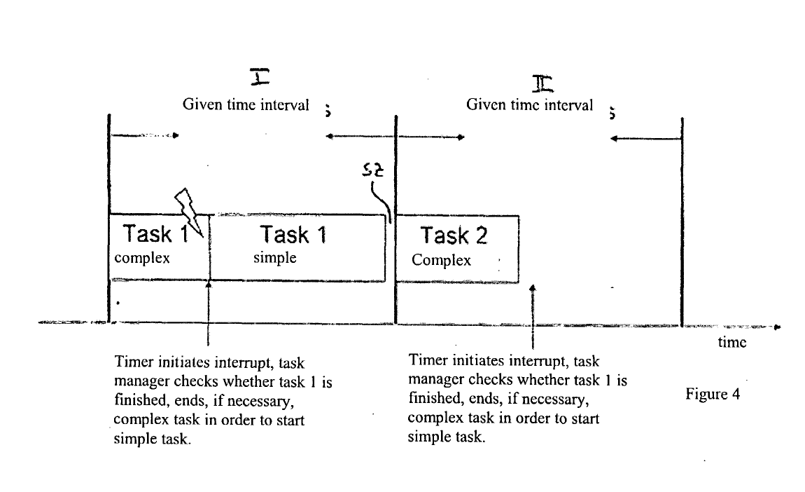

FIG. 4 shows the serial starting of tasks beginning with a task of a calculation time that is greater in comparison to the minimal task, and

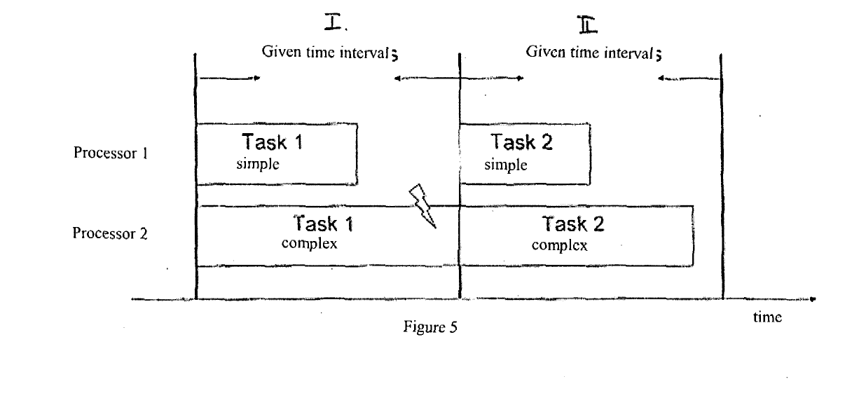

FIG. 5 shows the parallel calculation of tasks of different calculation times.

FIG. 1 shows by way of example one of the possible, previously cited possibilities of application in which it is provided that a data processing system operates as simulation computer and carries out the initially described process of the invention. It is provided here that the simulation computer simulates an environment for a concrete, real vehicle control device. A data- and signal exchange takes place between the simulating computer and the concrete control device, for example, regarding signals and data concerning information about the street, speed, wheel position, etc. The behavior of the control device regarding its control behavior in conjunction with an anti-locking system can be tested here in this example. The software running on the simulation computer for carrying out the process in accordance with the invention and task manager implemented in it starts the presented tasks in accordance with a given strategy, and a simple or a complex task, i.e., one with a short or a rather high calculation time is provided for the anti-locking system or an ESP system for controlling the slippage during starting or curve travel. According to the stored strategy the tasks provided here in the set of tasks are calculated in series or in parallel and the result of the calculation is made available to the control device in order to simulate an environment, that is, e.g., the driving of an automobile on the street for the control device and to get back its reactions to the simulated environment in a communication to the simulation computer.

FIG. 2 shows an alternative possibility of use in which the control device itself carries out the process in accordance with the invention; thus, the control device is not yet concretized as regards its electronic design but rather its control behavior is simulated by software. The process in accordance with the invention is also used here in which appropriate tasks with a lesser or greater calculation time, characterized as “simple” or “complex” are provided. It is not shown here that signals or data can be supplied from the outside to the control device for the simulation of its control behavior that stem, for example, from a real environment, for example, from a vehicle environment, with the data or signals obtained in this manner the control device makes initial magnitudes available by processing the task in accordance with the possible strategies of the invention, which magnitudes can directly influence the hydraulic equipment and/or the brakes of the concrete vehicle. It should be pointed out that the applications of FIGS. 1 and 2 shown here are to be understood only as exemplary and that there is no limitation of the process with the applications named here.

FIG. 3 clarifies the initially cited general manner of operation of the serial processing of tasks from the available set in an illustrative example. It is provided here that a higher task manager implemented in software always starts the calculation beginning with the minimal task, that is characterized as “simple” here, after a given time interval that constitutes the time period within which the simulation is periodically carried out. Thus, it turns out here in the first time period I that after the processing of the minimal task a task of greater complexity, i.e. with a higher calculation time and a potentially more precise result is started automatically by the task manager. It turns out here in the execution in period I that the task with the higher calculation time, that is marked here as complex, was not able to be completely calculated before the end of the time period, thus, this complex task was stopped and the result of the minimal task was taken here as the result for the calculation of simulation.

In the following period II the start of the calculation again takes place with the minimal task, according to which the task with a higher complexity is started, and it turns out here in the course of time that even the more complex task was able to be completely concluded in its calculation before the end of the time period. Thus, at the end of the time period and in accordance with the strategy present here the result of the task is taken that has the highest calculation time and/or complexity and was able to be completely calculated. It can be provided here as the dots show that after the complex task shown here even further following tasks of even greater complexity and/or calculation time can optionally be started whose processing can then optionally no longer be concluded within the provided time period.

FIG. 4 shows a presentation of the serial processing strategy according to which a start is made with a task of a higher calculation time in comparison to the minimal task, that is characterized here as simple. A timer is also started simultaneously with the start of the task, which timer initiates an interrupt after a set time. This initiation can take place, as presented in the general part, in order to ensure that there is still sufficient time available in the remaining residual time after the initiation of the interrupt and the end of the time period to start the minimal task. Thus, the view is shown here in period I according to which the complex task with the greater calculation time is stopped at the interrupt in order to make it possible that the minimal task can still be completely carried out in the time remaining until the end of the time period. It can be recognized here that the interrupt initiates when the difference of the maximally available time period and the time value of the timer is greater than the calculation time that the minimal task requires by a certain safety time SZ that is reflected here in that after the processing of the minimal task until the end of the time period this selected safety time remains. Thus, it can be ensured here by the safety time that any deviations in the stored calculation time of the minimal task due to certain environmental conditions do not have the result that the real-time capacity of the system is influenced.

It can be recognized in period II that prior to the initiation of the interrupt the complex task with a higher calculation time than the minimal task was able to be completely processed. Accordingly, no further task is started here by the task manager and the result of this complex task is evaluated as the result of the simulation.

FIG. 5 shows an embodiment of the parallel processing of different tasks on several processors, in this example only two processors of the data processing system, on which the process of the invention is carried out. A task is started here on each of the two processors 1 and 2 by the task manager implemented in software on the data processing system. This concerns the minimal task on processor 1 that makes the possibility available in a guaranteed fashion that the calculation of this task can be completely concluded within the available time period. It is apparent in the time period I shown here that processor 1 can conclude the processing of the minimal task within the available time, but not processor II, the one processing the more complex task with the higher calculation time. Accordingly, the calculation of the more complex task on processor 2 is stopped by the task manager after the ending of the available time period and only the calculation result of the minimal task is evaluated.

It is apparent in the further periodic execution according to process II that the minimal task was started again on processor 1, whose calculation was also able to be concluded within the available time period, but the calculation of the more complex task, which was therefore more calculation-intensive, was also concluded by processor 2 before the end of the time period. Accordingly, the task manager selects the result of the more calculation-intensive task on processor 2 as simulation result in accordance with the basic strategy.

It is apparent that the example offered here can also be carried out with even more processors than the two shown here and accordingly even more than two tasks with different calculation times can be started at the same time.

1. A process for carrying out at least one task for calculating at least one signal to be simulated in real time by a task manager implemented in software on a data processing system with a real-time operating system, which manager periodically starts a task after a time period that is given or can be given, wherein the task calculates at least one output signal from at least one given input signal which output signal is a function of the input signal, wherein a set of at least two different tasks with different calculation times for calculating the same at least one signal to be simulated is stored in an executable manner in the data processing system, and at least one minimal task has a calculation time shorter than the time period, in which the task manager starts at least one of the tasks from the set according to a stored strategy with which a calculation result of at least one of the tasks from the set is obtained while maintaining the real time within the given time period.

2. The process according to claim 1, wherein the minimal task is started in accordance with the stored strategy, after whose expiration at least one further task is started from the set with a greater calculation time than that of the minimal task, in which at the latest after the expiration of the time period a still-running task is stopped and the calculation result is taken as simulation result by the task that meets a deciding criterion that is given/can be given.

3. The process according to claim 2, wherein the deciding criterion is the calculation time, in particular the highest calculation time and/or the calculation precision, in particular the highest calculation precision and/or the simulation step size, in particular the smallest simulation step size and/or the solver or combinations thereof.

4. The process according to claim 2, characterized in that from the set of tasks beginning with the minimal task the further tasks are started in the series of rising calculation time.

5. The process according to claim 1, wherein a task from the set with a calculation time greater than that of the minimal task is started in accordance with the stored strategy, that a timer is started with the starting of this task, and that the task manager stops the started task and starts the minimal task as a function of the difference of time period and time value of the timer.

6. The process according to claim 5, wherein the stopping takes place at a time value of the timer when the difference of time period and time value is greater by a safety time than the calculation time of the minimal task.

7. The process according to claim 5, wherein an interrupt is initiated as a function of the time value of the timer, especially when the difference of time period and time value is greater by a safety time than the calculation time of the minimal task, and that a check is made in a procedure started by the interrupt whether the task has already ended, which task is stopped if it has not yet ended.

8. The process according to claim 5, wherein a task is started from the set with an expected greatest calculation time.

9. The process according to claim 5, wherein a task is started from the set whose expected calculation time is less than the timer time upon the stopping of the task in a previous calculation period.

10. The process according to claim 5, where upon a termination of the task before the interrupt the task manager waits until the expiration of the time period.

11. The process according to claim 5, where upon the termination of the task before the interrupt the task manager starts another task with an expected calculation time that is greater than that of the terminated task.

12. The process according to claim 1, wherein the data processing system comprises several processors working in parallel and that the task manager starts the minimal task and at least one further task from the set in parallel on each one of the processors, in which after the expiration of the period time the calculating result is taken as simulation result by the task of the parallel tasks that, from the completely executed tasks, meets a decision criterion that is given/can be given.

13. The process according to claim 12, wherein the deciding criterion is the calculation time, in particular the highest calculation time and/or the calculation precision, in particular the highest calculation precision and/or the simulation step size, in particular the smallest simulation step size and/or the solver or combinations thereof.

14. The process according to claim 1, wherein the process runs on a data processing system with which a test environment is simulated for a real electronic control device, and in which signals and/or data from the simulated environment of the control device are supplied to the real control device by the data processing system and the control device sends real signals and/or calculated data to the data processing system.

15. The process according to claim 1, that is carried out on a real electronic control device, in particular a vehicle control device, for the simulation of its control behavior, and in which signals and/or data from the real environment of the control device, in particular from sensors and measured-value receivers are supplied to the control device and the control device sends simulated signals and/or data calculated in a simulated manner to actors of the real control device environment.

16. The process according claim 1, that runs on a data processing system by means of which the control behavior of a control device, in particular of a vehicle control device, is simulated, in which signals and/or data are supplied to the data processing system from the real control device environment, in particular from sensors and measured-value receivers, or from a data processing system for the simulation of a control device environment, and simulated signals and/or data are supplied to the real or simulated control device environment from the data processing system simulating the control behavior.
